(19) United States
(12) Patent Application Publication
(10) Pub. No.: US 2019/0344897 A1
(43) Pub. Date: Nov. 14, 2019

(54) SHOCK CORD APPARATUS FOR DRONE RECOVERY SYSTEM

(71) Applicant: Indemnis, Inc., Anchorage, AK (US)

(72) Inventors: Warren Reasner, Wasilla, AK (US); Alan Erickson, Anchorage, AK (US)

(21) Appl. No.: 16/406,663

(22) Filed: May 8, 2019

Related U.S. Application Data
(60) Provisional application No. 62/668,726, filed on May 8, 2018.

(51) Int. Cl. B64D 17/80; B64D 17/08; B64D 17/24

(52) U.S. Cl. CPC B64D 17/80; B64C 2201/185; B64D 17/24; B64D 17/08

(57) ABSTRACT

An assembly for use with an aerodynamic decelerator for an aerial vehicle, such as a parachute, the assembly having a lead line with a first end and a second end, with the first end structured for attachment to the aerial vehicle, and an energy absorbing assembly having a first end attached to the second end of the shock cord and a second end structured for attachment to the parachute, the energy absorbing assembly in one implementation including an elongate flexible filament having first and second ends attached, the first end attached to the lead line and the second end attached to a decelerator. The first and second ends are attached to each other with rip-stitching, the first and second ends structured to break apart from each other in response to a load exerted by deployment of the parachute.

### BACKGROUND

### Technical Field

The present disclosure pertains to recovery systems for aerial vehicles and, more particularly, to a system having a deployable parachute assembly that attaches to the aerial vehicle with a lead line and shock cord attachment that minimizes entanglement of the aerial vehicle with shroud and bridle lines and the vehicle thrust generators during parachute deployment.

### Description of the Related Art

Recent advancements in drone and personal-unmanned aerial vehicle technology have greatly reduced the cost of these vehicles and made them readily available to the general public. Although these vehicles are more affordable than in previous years, their cost is still significant enough to warrant some protection against damage resulting from inflight failure.

When an inflight failure occurs, aerial vehicles generally begin to plummet towards the ground, at times resulting in loss of control. Drone vehicles in particular are prone to tumbling when control is lost because they do not have the capability to glide, hover, or float. Inflight failures generally cannot be corrected before the vehicle hits the ground due to low flying altitudes or non-recoverable failures (e.g., a dead battery). Such crashes often leave the vehicle with major, or even irreparable, damage. In addition there is a risk of damage to property and injury to people and animals as the vehicle tumbles to the ground.

Some aerial vehicles utilize traditional parachute systems to slow a descent of the vehicle. These parachute systems, however, generally work so long as the aerial vehicle is upright during the entire deployment phase of the parachute. Unfortunately, many failures will lead to sporadic and uncontrollable movement or descent of the vehicle such that parachutes cannot be properly deployed, often resulting in the aerial vehicle crashing despite an attempt to deploy a traditional parachute system.

The industry currently uses a shock cord or bungee cord to assist the parachute in properly opening. Typically the shock cord is placed at the base of or at a rigid connection point on the object being decelerated. The problem with this method is that it does not allow for the energy absorption to occur before the parachute lines become entangled with the object.

### BRIEF SUMMARY

The present disclosure is directed to a shock absorption device, such as an elastic filament, bungee cord, or a rip-stich decelerator (RSD) cord coupled to a drone and an aerodynamic decelerator device via a lead line to reduce, and in some cases eliminate, the chance of entanglement, and to enable the aerodynamic decelerator to work effectively. It is with respect to these and other considerations that representative implementations of the present disclosure have been made.

In accordance with one aspect of the present disclosure, an RSD is provided to function as a shock load absorption device, taking the load transfer from an accelerated aircraft to a parachute, and expanding the impulse time, thus reducing the maximum amount of force seen by both aircraft and parachute.

The RSD is one component of an inflatable deployment apparatus for a descent restraint system. One function is to move the energy absorption away from any potential area of entanglement. Another function is to absorb shock and reduce the impulse load at a graduated interval, therefore reducing the potential for damage to both the aircraft and the aerodynamic decelerator, such as a parachute.

In accordance with one aspect of the present disclosure, the design of the assembly protects the positioning of the lead line in collaboration with the RSD. While most systems put the “shock cord” first, it is closer to the drone and frequently bounces back and entangles with the drone, for example, the thrust generators or rotors, landing gear, and the like.

In accordance with a further aspect of the present disclosure, a parachute deployment assembly for use with an aerial vehicle is provided. The assembly includes a lead line having a first end and a second end, with the first end structured for attachment to the aerial vehicle, and an energy absorbing assembly having a first end or surface attached to the second end of the lead line and a second end or surface structured for attachment to the parachute, the energy absorbing assembly including an elongate flexible filament having first and second ends attached together, preferably with rip-stitching, the first and second ends attached to the second end of the shock cord and structured to break in response to a load exerted by deployment of the parachute.

In accordance with another aspect of the present disclosure, an aerial vehicle is provided that includes a parachute; and a parachute deployment assembly that includes a lead line having a first end and a second end, with the first end attached to the aerial vehicle, and an energy absorbing assembly having a first end or surface attached to the second end of the lead line and a second end or surface attached to the parachute, the energy absorbing assembly comprising an elongate flexible filament. The parachute deployment assembly may have the aspects previously described above or in more detail below.

### BRIEF DESCRIPTION OF THE SEVERAL VIEWS OF THE DRAWINGS

The foregoing and other features and advantages of the present disclosure will be more readily appreciated as the same become better understood from the following detailed description when taken in conjunction with the accompanying drawings, wherein:

FIG. 1 is a side view of an aerial vehicle, such as a drone, having an aerodynamic decelerator system coupled there to in a deployment condition;

FIG. 2 is an enlarged partial side view of the rip-stitch decelerator assembly as it is deploying from the aerial vehicle; and

FIG. 3 is a further enlarged side view of the rip-stitch decelerator assembly as the rip-stitching is unraveling to absorb energy.

### DETAILED DESCRIPTION

In the following description, certain specific details are set forth in order to provide a thorough understanding of various disclosed implementations. However, one skilled in the relevant art will recognize that the present disclosed implementations may be practiced without one or more of these specific details or with other methods, components, materials, etc. In other instances, well-known structures or components or both that are associated with the environment of the present disclosure have not been shown or described in order to avoid unnecessarily obscuring descriptions of the implementations.

Unless the context requires otherwise, throughout the specification and claims that follow, the word “comprise” and variations thereof, such as “comprises” and “comprising” are to be construed in an open inclusive sense, that is, as “including, but not limited to.” The foregoing applies equally to the words “including” and “having.”

Reference throughout this description to “one implementation” or “an implementation” means that a particular feature, structure, or characteristic described in connection with the implementation is included in at least one implementation. Thus, the appearance of the phrases “in one implementation” or “in an implementation” in various places throughout the specification are not necessarily all referring to the same implementation.

As used herein, the term “aerial vehicle” refers to a powered airborne object that is controlled by a user or autonomous, such as through an automated position-control system. Examples of aerial vehicles can include, but are not limited to, unmanned aerial vehicles, drones, manned aerial vehicles, or the like.

Reference throughout this description to a “tube” means a lightweight, flexible, hollow body having a circumscribing wall that defines a longitudinal axial bore that can be inflated with a gas or other fluid to create a semi-rigid structure. Tubes can be linear, arcuate, circular, oval, or a variety of other shapes that perform similar functions to those that are described and illustrated herein. Well-known structures and components associated with parachutes and canopies will not be described in detail herein.

The following is a brief description of the use, operation, and purpose of the parachute system described herein. As the use of drones and other unmanned aerial vehicles increases, so too does the risk of inflight failures. Failures can occur in all different types of situations, environments, and vehicle altitudes. The use of aerial vehicles in urban areas has increased the desire for a system to allow an aerial vehicle that experiences an inflight failure to land without causing harm to people, animals, homes, or other property. Similarly, aerial vehicle owners desire and prefer a system that protects the aerial vehicle from extensive damage due to a fall from altitude.

A typical parachute system for aerial vehicles, particularly unmanned vehicles such as drones, includes a detection computer system, sensors, an inflation mechanism or device, and an parachute assembly. The detection computer system, or control circuitry, is operable to detect an uncontrolled flight condition of the aerial vehicle and to output a signal in response to the detected condition. These detection systems utilize different types of sensors (such as gyroscopes, accelerometers, altimeters, GPS systems, or the like) and algorithms to detect if the aerial vehicle has gone into an uncontrolled condition. An uncontrolled condition may be an uncontrolled descent, an unintentional unpowered descent, other uncontrolled movements, flight of the aerial vehicle into an unapproved or unauthorized location or altitude, etc.

Examples of an uncontrolled flight condition may be that one or more of the engines or motors of the aerial vehicle loses power—resulting in a loss of lift to the aerial vehicle. Another uncontrolled flight condition may be that the aerial vehicle stops responding to operating commands from a remote control of a user. In yet another example, the aerial vehicle may be too close to the ground or near structures or is on a collision course with a structure or person. It should be recognized that other uncontrolled or potentially hazardous flight conditions may also be detected by the detection computer system.

Upon detection of an uncontrolled flight condition, the detection computer system outputs a signal that can be used for a variety of different safety measures. For example, the signal can bypass the avionics controller and cut power to the motors, which stops the motors and the attached rotors from spinning. The signal is also received by a controller of the inflation mechanism and is configured to initiate deployment of an parachute assembly, as described herein. In some implementations, users can manually input, such as from a remote control, the detection signal to initiate deployment of the parachute assembly.

Upon receiving a detection signal of uncontrolled flight, such as a fall detection signal, a servo or other controller opens or otherwise activates the inflation mechanism—which is in fluid communication with the parachute assembly—to inflate, and thus deploy, the parachute assembly. As described elsewhere, the inflation mechanism may be compressed air, a pump, a solid-propellant inflator, other explosion- or chemical-based inflators, etc.

Prior to deployment, the parachute assembly is stored in a deflated state in a housing on the aerial vehicle (not shown). Upon deployment, an initial burst of gas from the inflation mechanism pushes the parachute assembly out of its housing and away from aerial vehicle. This burst of gas likewise pushes the aerial vehicle in an opposite direction of the deployment of the parachute assembly, which helps to create some distance between the aerial vehicle and the parachute assembly. This partial separation allows the parachute assembly to deploy without interference by the aerial vehicle.

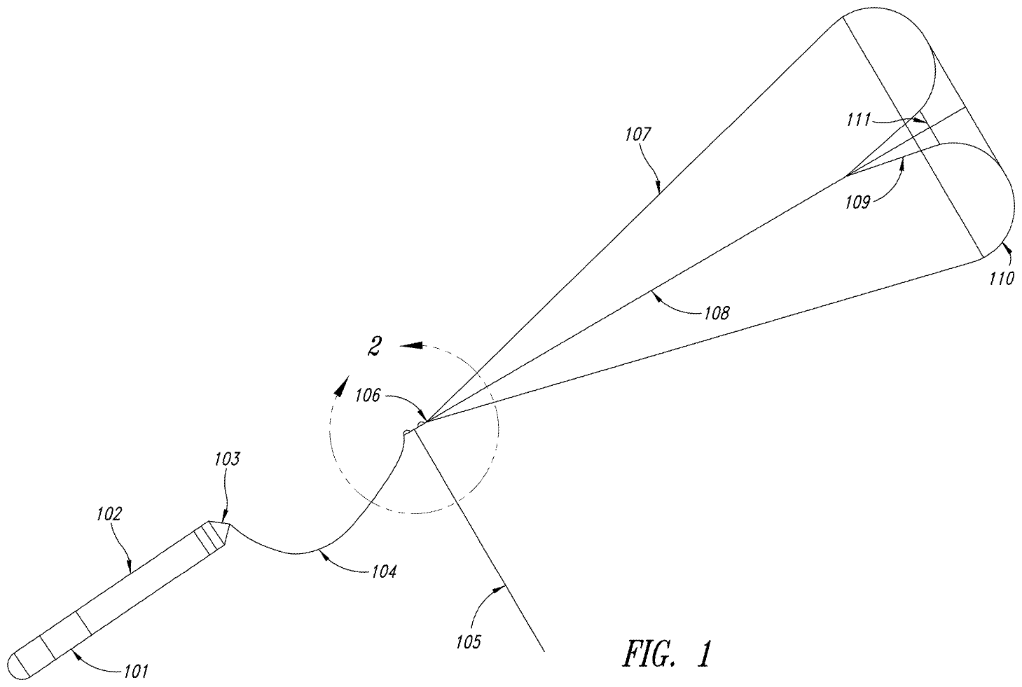

Referring to FIGS. 1-3, an aerodynamic decelerator assembly is provided as shown therein. The assembly is packed in a housing assembly 101 “accordion” style inside of a packed parachute canopy 110, along with outer shroud lines 107 and an inner shroud line 109, apex line 108, and connecting line 111.

A lead line 104 is attached on one end to a deployment tube 102 of a line support 103, looped through a tear away paper band, and runs into the bottom side of the packed parachute 110. The other end of the lead line 104 is attached to a bottom side of a shock absorbing device, as shown in this implementation a rip-stich decelerator (RSD) 105. It is to be understood that the shock absorbing device can be an elastic filament, such as a bungee cord, elastic flat webbing or, in this implementation, the rip-stitch decelerator device RSD 105, which is described in more detail below.

During the deployment phase of the system, the deployment tube 102 will ballistically drive the parachute pack out of the housing assembly 101. Upon reaching full extension, the rigid deployment tube will release the parachute pack into the air.

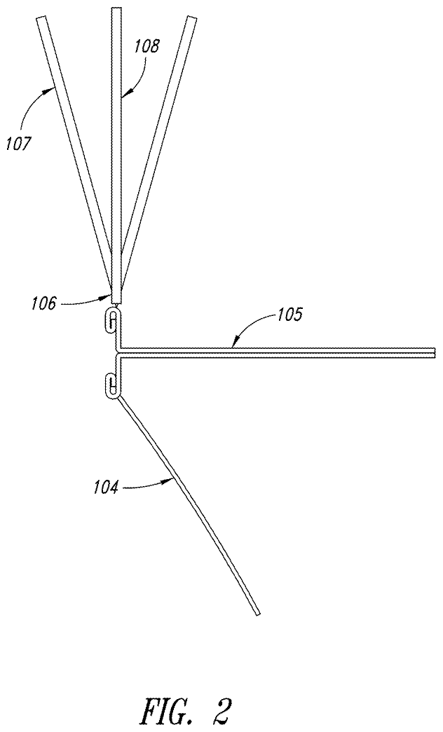

The lead line 104, after breaking a paper band, will begin to stream out of the bottom side of the parachute pack. Upon reaching its full length, the lead line 104 will pull the RSD 105 out of the parachute pack, followed by the parachute lines 107, 108, 109, which are attached to a top side of the RSD 105. The parachute canopy 110 will continue to its full extension as shown in FIGS. 1 and 2. At full extension the parachute canopy will be inflated and exert a force on the lead line 104.

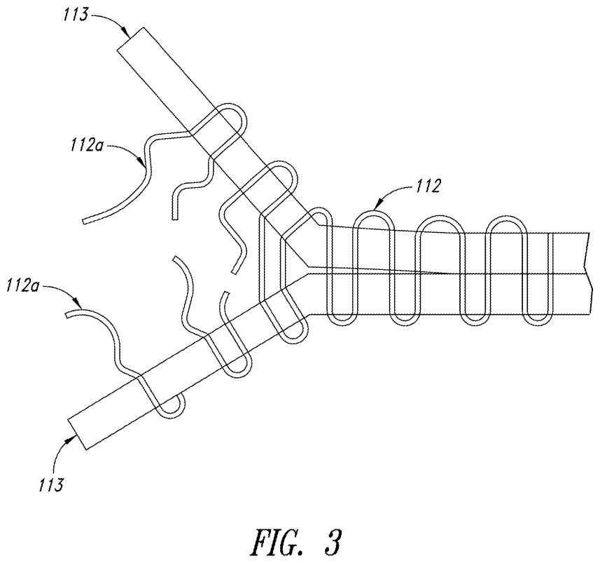

As shown in FIG. 3, the RSD 105 is constructed using one continuous piece of webbing 113 that may not be elastic or stretchable. To provide a resiliency or elastic effect that creates a deceleration, the two ends of the webbing 113 are doubled over themselves and stitched together to create an attachment loop. The RSD 105 is then folded in half and stitched with a style of stitching 112 that does not run back over its self. The stitching itself can be done in a straight or z-type pattern and is determined by the requirements of the aircraft being decelerated. The webbing 113 may be folded in half again or folded in thirds or in other proportions with additional rip-stop stitching to create an additional deceleration effect.

The lead line 104 is attached to a bottom surface of the RSD 105 and the parachute lines 107, 108, 109 are attached to the opposing top surface of the stitched RSD 105. If a bungee cord or other elastic filament is used, then the rip stitching may not be needed because the elasticity of the bungee cord or elastic filament provides a deceleration effect. However, stitching may be added to provide additional controlled deceleration during deployment of the parachute.

As the load begins to pull on the two sides of the RSD 105, the stitches will being to stretch until enough load is reached to cause the first group of stitches 112a to break, which is shown in FIG. 3. These stitches 112a will continue to break until the load on the RSD is less than or equal to that of the stitching.

In accordance with another aspect of the present disclosure, the webbing is preferably a nylon material or similar material in terms of resiliency, stretch, strength, and weight. The stitching can be done with commercially available thread, single or multiple strand thread, and preferably a thread that can be readily used in commercial manufacturing and that withstands the temperatures and humidity within the tube during storage and deployment. In one implementation the thread is 4 oz nylon. The strength of the stitching is determined by the amount of stitches per inch that are present, which allows the RSD 105 to be “staged” in differing resistance levels according to the deceleration need. Ideally the RSD 105 is constructed in a way (stitches per inch and length) that decelerates the impulse load within 80% of the stitched part of the RSD 105.

The RSD 105 is always attached after the lead line 104 and before a bridal 106 of the parachute (FIG. 2). It is done this way due to a “spring” back effect experienced in internal testing due to the velocities of deployment. The loops on the ends can be attached by just knotting the lines around the loops of the RSD 105 or by a mechanical means, such as a metal quick link. Positioning the RSD 105 after the lead line 104 also helps to keep it out of any entanglement area.

As discussed above, the RSD 105 can be a bungee cord or elastic filament that may have its ends stitched together or not stitched together. An important feature of the present disclosure is the placement of the lead line between the parachute and the RSD 105 or shock absorbing device, which aids in preventing the shock absorbing device from becoming entangled in the parachute, as well as in the rotors or thrust generators of the aerial vehicle.

The various implementations described above can be combined to provide further implementations. Aspects of the implementations can be modified, if necessary to employ concepts of the various patents, applications and publications to provide yet further implementations.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A parachute deployment assembly for use with an aerial vehicle and a parachute, comprising:
a lead line having a first end and a second end, with the first end structured for attachment to the aerial vehicle; and
an energy absorbing assembly having a first end or surface attached to the second end of the lead line and a second end or surface structured for attachment to the parachute, the energy absorbing assembly comprising an elongate flexible filament.

2. The parachute deployment assembly of claim 1 wherein the energy absorbing assembly has first and second ends attached together with rip-stitching, the first and second ends structured to be attached to the second end of the lead line and to the parachute, respectively, and structured to break apart in response to a load exerted by deployment of the parachute.

3. The parachute deployment assembly of claim 1 wherein the energy absorbing assembly comprises an elastic filament with first and second ends stitched together with rip-stitching done in a straight or z-type pattern.

4. The parachute deployment assembly of claim 3 wherein the elastic filament is folded over onto itself twice and held in place with the rip-stitching.

5. An aerial vehicle, comprising:
a parachute; and
a parachute deployment assembly that includes:
a lead line having a first end and a second end, with the first end attached to the aerial vehicle; and
an energy absorbing assembly having a first end or surface attached to the second end of the lead line and a second end or surface attached to the parachute, the energy absorbing assembly comprising an elongate flexible filament.

6. The parachute deployment assembly of claim 5 wherein the energy absorbing assembly has first and second ends attached together with rip-stitching, the first and second ends structured to be attached to the second end of the lead line and to the parachute, respectively, and structured to break apart in response to a load exerted by deployment of the parachute.

7. The parachute deployment assembly of claim 5 wherein the energy absorbing assembly comprises an elastic filament with first and second ends stitched together with rip-stitching done in a straight or z-type pattern.

8. The parachute deployment assembly of claim 7 wherein the elastic filament is folded over onto itself twice and held in place with the rip-stitching.
